(19) United States
(12) Patent Application Publication
(10) Pub. No.: US 2006/0213076 A1
(43) Pub. Date: Sep. 28, 2006

(54) Pressing device and method for use in a lumber dryer

(76) Inventors: Alain Bilodeau, Normandin (CA); Eric Cloutier, St-Felicien (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/386,767

(22) Filed: Mar. 23, 2006

(30) Foreign Application Priority Data
Mar. 24, 2005 (CA) 2,502,252

(51) Int. Cl. F26B 19/00

(52) U.S. Cl. 34/212

(57) ABSTRACT

The pressing device has at least one vertically extending guiding member and a pressing member extending horizontally above a lumber stack loading area. The pressing member is slidably connected to the guiding member in a manner to be movable into contact with the stack of lumber to apply a downward compressive force to it.

### CROSS-REFERENCE TO RELATED APPLICATION

This application claims priority on Canadian patent application No. 2,502,252, filed Mar. 24, 2005, entitled “Wood Stabilizer Apparatus”, the contents of which are hereby incorporated by reference.

### FIELD

The present invention relates to a pressing device and a method of drying lumber for mitigating the warping of wood planks during drying.

### BACKGROUND

When drying wood planks in a lumber dryer, the planks have a natural tendency of warping and distorting as water evaporates. This can be partly mitigated by organizing wood planks in a stack since the overall weight of the wood stack produces a downward compressive force on the lower planks therein. The resulting forces help prevent the lower planks from warping and provide at least some guidance for the deformations occurring in the longitudinal direction. However, with such an arrangement, the upper planks have less or no compressive force acting on them, thereby being prone to warping and distortion.

Adding weights on the top of a wood stack may be useful to solve the problem of warping and distortion of the planks in the upper part of the stack. However, this may require additional manipulation and complexity to the process. It is also time consuming. One challenge is that the force generally needs to be important and evenly applied. Secondly, the space available in a lumber dryer is limited and these dryers must be loaded at a maximum capacity to be optimally efficient.

### SUMMARY

An aim of the improvements is to alleviate some of the needs concerning lumber drying.

In accordance with one aspect, there is provided a pressing device for use in a lumber dryer having a lumber stack loading area. The pressing device comprises: at least one guiding member extending substantially vertically, and a pressing member slidably connected to the guiding member, the pressing member extending substantially horizontally above the stack loading area and being slidable between a loading position and a pressing position, a downward compressive force being applied by the pressing member to a lumber stack loaded in the loading area of the dryer when the pressing member is in the pressing position.

In accordance with another aspect, there is provided a pressing device for use in a lumber dryer having a lumber stack loading area. The pressing device comprises a pressing member extending substantially horizontally above the lumber loading area; and means for vertically moving the pressing member while holding it from a side thereof so as to apply a downward compressive force to a lumber stack in the loading area.

In accordance with still another aspect, there is provided a method of maintaining a stack of lumber during drying, the method comprising: supporting a substantially horizontal pressing member from one side thereof; positioning a stack of lumber beneath the pressing member; moving the pressing member downwardly while keeping it in a substantially horizontal position until it makes contact with an upper portion of the stack of lumber; and continuing to move the pressing member so as to apply a downward compressive force to the stack of lumber.

### DESCRIPTION OF THE FIGURES

Further features and advantages of the present invention will become apparent from the following detailed description, taken in combination with the appended figures, in which:

FIG. 1 is a perspective view showing an example of an improved pressing device for drying lumber;

FIG. 2 is a front elevation view of the pressing device of FIG. 1;

FIG. 3 is a top plan view of the pressing device of FIG. 1;

FIG. 4 is an enlarged perspective view showing the sliding assembly of the pressing device of FIG. 1;

FIG. 5 is an exploded view showing the sliding assembly of the pressing device of FIG. 1;

FIG. 6 is an enlarged partial view showing the actuator assembly of the pressing device of FIG. 1;

FIG. 7 is a perspective view of another example of an improved pressing device for drying lumber; and

FIG. 8 is a front elevation view of the pressing device of FIG. 7.

### DETAILED DESCRIPTION

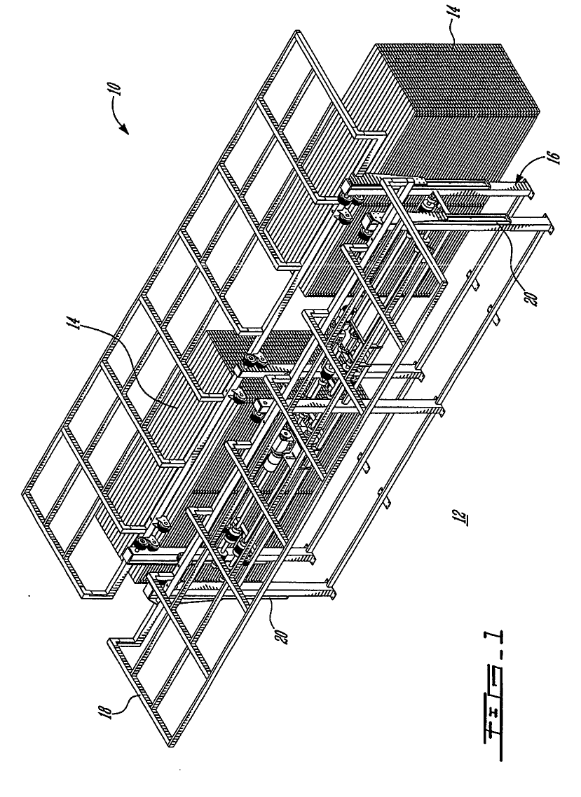

FIGS. 1 to 3 show an example of an improved pressing device 10. The pressing device 10 is adapted for use in a lumber dryer (not shown). The illustrated pressing device 10 is double sided. Each side is independent from the other and has a corresponding stack loading area 12 where the lumber stack 14 is positioned during the drying process. Both sides are mounted to a common frame 16. It should be noted that only one of these two sides will be described in detail, the other side being similar to the one described herein.

The pressing device 10 includes a pressing member which extends horizontally over a stack loading area. The pressing member 18 is slidably connected to one or more guiding members 20 extending substantially vertically from the floor of the dryer. The pressing member 18 is vertically displaceable to apply a downward compressive force onto a loaded stack of lumber. It can also be moved upwardly to allow loading and unloading the lumber stack. The illustrated pressing member 18 is a cantilever pressing member 18; it is cantilevered relative to the guiding members 20.

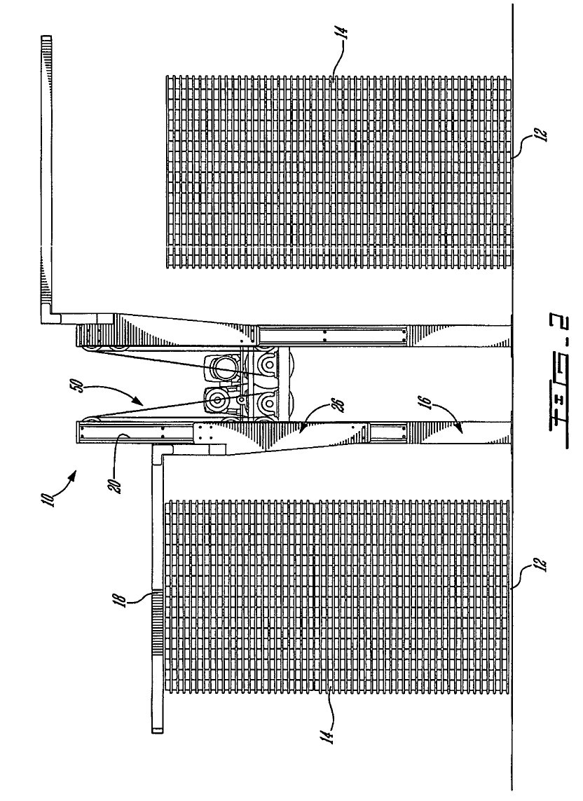

In FIG. 2, the left hand side pressing member 18 is shown in a pressing position, and the right hand side pressing member 18 is shown in a loading position. The pressing device 10 has an actuator assembly which will be described further below.

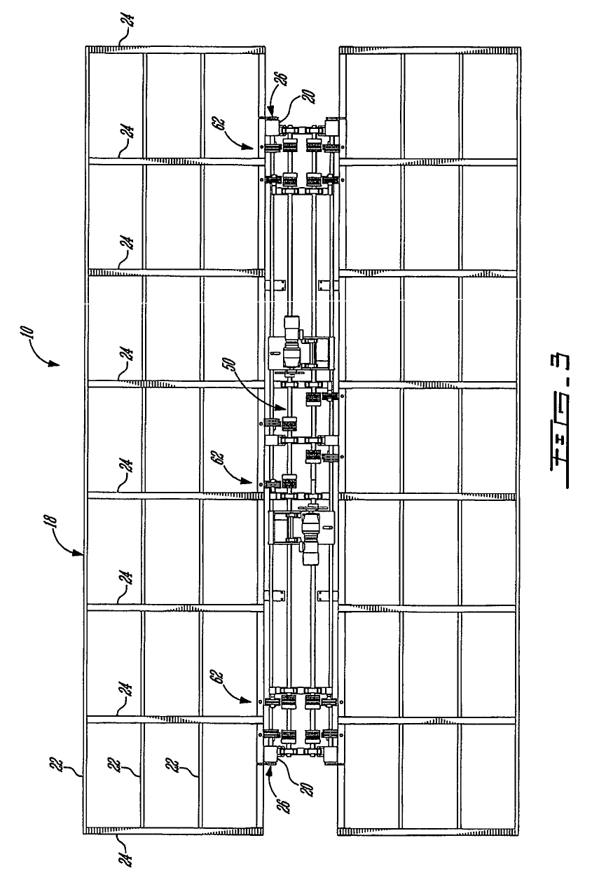

Referring to FIG. 3, the pressing member 18 in this example includes a plurality of longitudinally-disposed beams 22 and a plurality of transversally-disposed beams 24 in a cross-hatched pattern along a common plane. This configuration is adapted for applying the downward compressive force on the loaded stack 14 in a horizontally dispersed manner, and reduces points of high-force concentration.

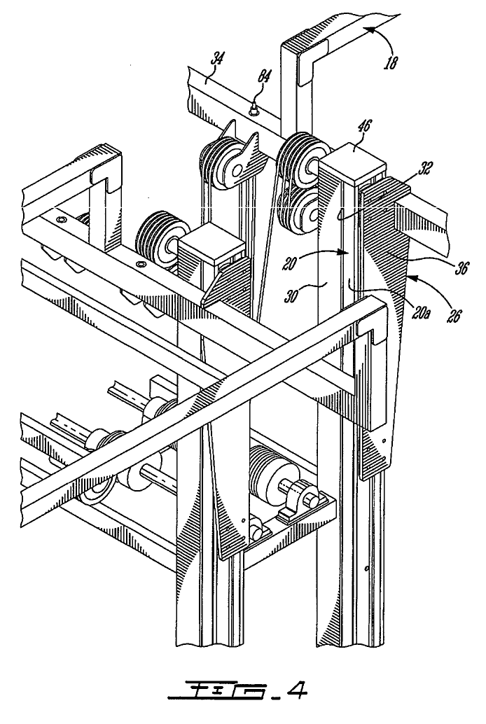

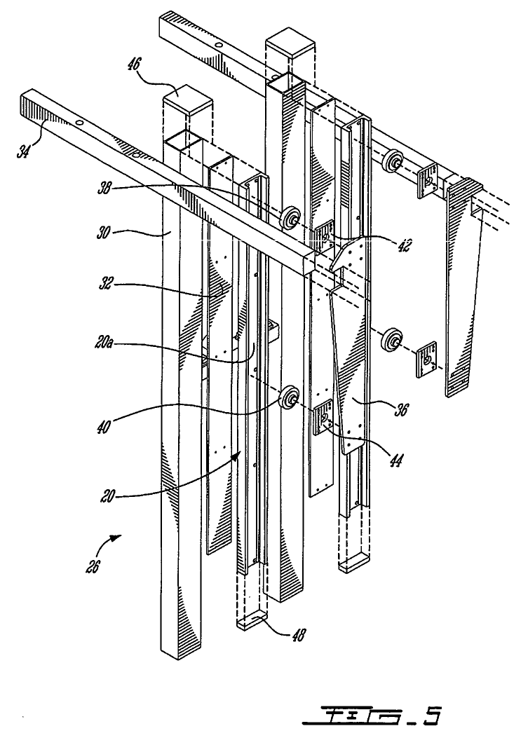

Referring to FIGS. 4 and 5, the manner in which the pressing member 18 is slidably connected to the guiding members 20 in this example is shown in greater detail. The pressing member 18 is slidably connected to each guiding member 20 via a respective sliding assembly 26. The two longitudinally opposite guiding members 20 have identical sliding assemblies 26, and therefore only one will be described in detail. In this example, the guiding member 20 has a vertically disposed rail 20a which is mounted to a vertical frame member 30 with a backing plate 32 therebetween. The longitudinally-disposed beams 22 and transversally-disposed beams 24 of the pressing member 18 are connected to a mounting beam 34 which defines a side of the pressing member 18. In this example, the mounting beam 34 is lower than the plane of the transversally and longitudinally extending beams (22, 24; see FIG. 3). The mounting beam 34 is affixed to a sliding support 36. The sliding support 36 has an upper roller 38 and a lower roller 40, both of which are spaced apart and mounted to the sliding support 36 via a respective upper positioning plate 42 and lower positioning plate 44. The rollers 38, 40 slide within the rail 20a when the pressing member 18 is lifted and lowered. The spacing between the rollers 38, 40 acts as a leverage which counteracts the moment of force applied to the mounting beam 34 when a downward force is applied by the pressing member 18 to a stack of lumber 14. The upper and lower ends of the rails 20a have a respective upper stopper plate 46 and lower stopper plate 48 affixed thereon. The upper stopper plate 46 limits the upward vertical sliding movement of the pressing member 18, and the lower stopper plate 48 limits the downward vertical sliding movement of the pressing member 18. As it will be apparent to those skilled in the art, any other suitable sliding assembly 26 can be used.

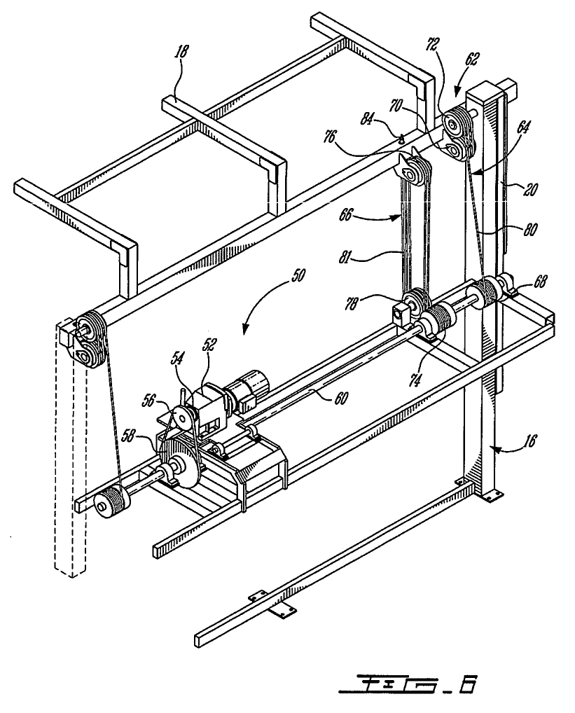

The actuator assembly 50 provided in the illustrated embodiment is shown in greater detail in FIG. 6. It includes an electric motor 52 which has a driveshaft 54 with a driving pulley 56 mounted thereon. The driving pulley 56 is connected to a multiplying pulley 58, the multiplying pulley 58 itself being mounted to a main shaft 60 which is rotatably mounted to the frame 16 of the pressing device 10. In this example, three substantially identical pulley systems 62 are used to connect the main shaft 60 to the pressing member 18 (see FIGS. 1 and 3). The three pulley systems 62 are longitudinally spaced apart along the main shaft 60. In FIG. 6, only one of the pulley systems 62 is illustrated and will be described. The pulley system 62 includes a lifting assembly 64 and a lowering assembly 66. The lifting assembly 64 is adapted to apply a lifting force to the pressing member 18, and the lowering assembly is adapted to apply a lowering or downward force to the pressing member 18.

The lifting assembly 64 includes a lifting winder 68 mounted to the main shaft 60, a set of movable pulleys 70 mounted to the pressing member 18, and a set of fixed pulleys 72 mounted to the frame 16 of the pressing device 10, above the movable pulleys 70. The lowering assembly 66 includes a lowering winder 74 mounted to the main shaft 60, a set of movable pulleys 76 mounted to the pressing member 18, and a set of fixed pulleys 78 mounted to the frame 16 of the pressing device 10, below the movable pulleys 76.

In each of the lifting assemblies 64 and lowering assemblies 66, a respective lifting cable 80 and lowering cable 82 is wound to the winder, joins a fixed pulley and a movable pulley, and back to a fixed pulley and so forth until a fixed pulley is joined to the pressing member 18. In this example, the number of fixed pulleys in each assembly is of three, and the number of movable pulleys is of two. Those skilled in the art will understand that more or less force multiplication can be used. In this example, both the lifting winder 68 and the lowering winder 74 are mounted to the main shaft 60 in such a manner as to be rotated by the main shaft 60, but to be longitudinally displaced along the main shaft 60. This is achieved by the main shaft 60 having a longitudinal slot and being connected to a keyway of the winder, the keyway matching the slot (both of which are not shown) as it is known to those skilled in the art. The winding direction of the lifting winder 68 is opposite to the winding direction of the lowering winder 74 relative to the axis of the main shaft 60.

In this example, one end of each one of the cables 80, 82 is attached to the pressing member 18 via a threaded fastener 84. This allows precisely adjusting the extension length of the cables manually by adjusting the penetration depth of the threaded fastener.

It will be noted that, in this example, the pulleys are arranged for the cables to work substantially in the direction of displacement of the pressing member 18 (i.e. vertically). This contributes to maximizing the use of the motor torque.

The motor 52 used in this example is an electric motor which has a brake made integral with it, as known in the art. The brake is automatically applied then the power is interrupted, and automatically released as soon as power is applied to the motor. In the event of a power failure during pressing, the brake is automatically applied and some downward force continues to be applied to the stack of lumber 14. If a power failure happens when the pressing member 18 is in the loading position, the brake is automatically applied and prevents the pressing member 18 from sliding down along the guiding members 20. The electric motor can be configured for the brake to be automatically applied when the pressing member 18 is slid into the loading position and the upper roller 38 of the sliding assembly 26 encounters the upper stopper plate 46 (FIG. 5).

In this example, a direct torque control™ (DTC™) driving unit (not shown), supplied by ABB (see www.abb.com), was used to control the electric motor 52. The driving unit is electrically connected between the motor 52 and a power supply. Using this type of driving unit allows maintaining motor torque when applying the downward force to a stack of lumber 14, even when the driveshaft 54 does not turn (0 RPM torque). Furthermore, using this type of driving unit allows selecting the amount of compressive force applied depending on the type of stack of lumber. Such a motor also has a relatively low energy consumption during the period of force application, which can extend several hours in the case of lumber drying. Yet, such a driving unit allows maintaining a substantially constant compressive force to the stack of lumber 14 even though some mechanical changes (e.g. cable stretching) can occur in the equipment or in the configuration of the stacks during drying, such as may be caused by heat generated by the dryer.

In this example, a signaling light (not shown) may be provided to indicate the status of the pressing device 10, and the pressing device 10 can be made to function entirely unmanned.

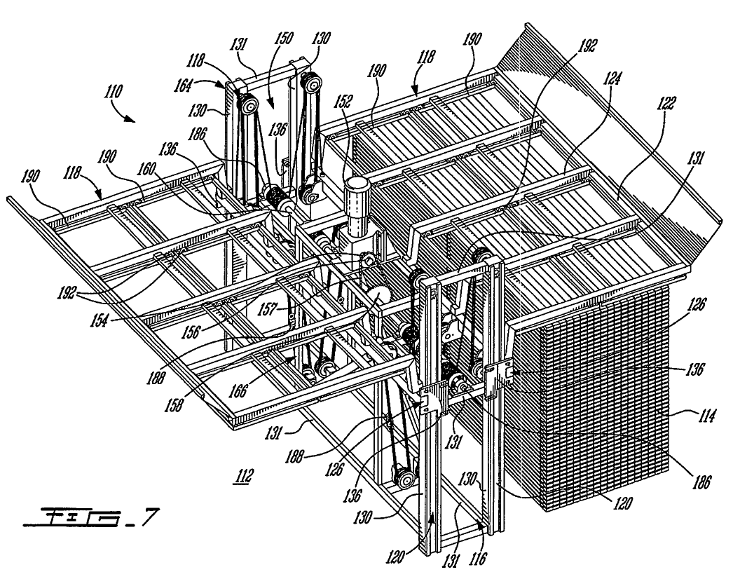

Referring now to FIG. 7, another example of a pressing device 110 is shown. This pressing device 110 has two opposed pressing members 118 mounted on a common frame 116, the opposed pressing members 118 being driven together with a single motor 152 via a shared actuator assembly 150.

The frame 116 is fixedly mounted to the ground, to the floor of the heating unit, or to any other immobile structure (not shown). In an alternate embodiment, the frame 116 can be moved to specific locations in the heating unit by being mounted on a railing system (not shown), for example. The frame 116 includes a plurality of vertical frame members 130 and a plurality of horizontal frame members 131 fixedly mounted to one another.

In this example, the vertical frame members 130 are longitudinally spaced apart from each other and include guiding members 120 which are adapted to slidably connect the pressing members 118 to the frame 116. The vertical frame members 130 and the horizontal frame members 131 altogether define a plurality of potential mounting supports for the actuator assembly 150, as will be further explained below.

The pressing members 118 each include two opposed sliding supports 136, each sliding support 136 being associated to a respective guiding member 120. In this example, the sliding supports 136 each have four rollers which are built to roll alongside the guiding members 120. Two pairs of rollers are thus provided, each pair of roller being is spaced apart from the other pair such as to be positioned on opposite faces of the guiding members 120 and thereby allow a slidable connection between the pressing member 118 and the frame 116 upon movement of the pressing member 118.

The electric motor 152 includes a driveshaft 154 which has a driving sprocket 156. The driving sprocket 156 is connected to a multiplying sprocket 158 with a chain 157. The multiplying sprocket 158 is mounted to the main shaft 160. The motor 152 is fixedly mounted to the supporting structure of the frame 116. The motor is further provided with a brake which prevents the driveshaft 154 from rotating when there is no current being supplied to the motor 152.

The main shaft 160 is rotatably supported on the frame 116 via bearing assemblies 186 mounted on the frame 116 and is provided with winders. The winders are fixedly mounted at predetermined positions along the shaft and are configured and sized to cooperate with pulleys in moving the pressing members 118. In this embodiment, the winders are double winders and each feed a cable to two pulley systems, each pulley system being associated with a respective pressing member 118. Two lifting pulley assemblies 164 and two lowering pulley assemblies 166 are provided along the main shaft 160 for each pressing member 18.

In use, a pressing device 110 of this example may function as follows. First, the pressing member 118 is set at a loading position that corresponds to a predetermined distance above the floor of the heating unit which is higher than the stack of lumber 114 to be dried. The stacked lumber 114 may then be positioned in the loading area 112, below the pressing member 118.

Upon actuation of the motor 152, the driveshaft 154 is rotated in a lowering direction and drives the driving sprocket 156 which cooperates with the chain 157 to drive the multiplying sprocket 158. The multiplying gear 158 drives the main shaft 160. The winders follow the induced rotation of the main shaft 160 in the charging direction. The cable which is wound on the lifting half of the winder starts to unroll and pivots about the fixed pulley and the movable pulley. At the same time, the cable which is wound on the lowering half of the winder starts to wind around the winder and pivots about the fixed pulley and the mobile pulley mounted on the pressing member 118. The tension created in the lowering cable pulls the pressing member 18 downwardly into contact with the stacked lumber 114. The pressing member 118 reaches a pressing position when the pressing member 118 comes into contact with the highest stack of lumber.

Depending on the charging force required on the stacked lumber, the cable continues to be rolled around the roller such that tension builds in the cable which allows the guider compressing the highest lumber stack 114.

When the required charging force on the stacked lumber 114 has been reached, the motor 152 is shut down and the internal brake (not shown) helps maintaining the charging force by keeping the tension in the cables. The heaters (not shown) in the heating unit may then be activated such as to circulate heated air to dry the bundles of wood while the pressing device 110 provides controlled deformation guidance to the lumber.

Accordingly, the charging force imposed on the stacked lumber 114, may be adjusted during the drying process by operating the pressing device 110 as described previously.

When the drying process comes to an end, the motor 152 may once again be actuated in a reversed free direction such that the tension built in the lowering cable is released, and consequently, the charging force imposed by the pressing member 118 on the stack 114 is released.

At that time, the lifting cable of the actuator assembly starts to wound around the lifting portion of the winder, and lifts the pressing member 118.

This combined effect of the actuator assembly 150 moves the pressing member 118 upwardly away from the highest stack. The pressing member 118 is then at the loading position. At that time, the lumber stack 114 may be removed from the apparatus.

In this example, the lowering assemblies 166 include an electronic load cell 188. The electronic load cell 188 is in signal communication with the motor 152 and is mounted to the lowering cables of the actuator assembly 150 for monitoring the tension force in the cables. The load cell 188 is positioned in the portion of the cable which links the last pulley to the pressing member 118.

In operation, upon reading a tension variation in the cable above or below preset values, the electronic load cell 188 sends a signal actuating the motor for either rotating in the charging direction if more tension is needed in the cable or for rotating in the free direction if less tension is needed in the cable.

The electronic load cell 188 may further be programmed with charging force data corresponding to various types of woods. Each type of wood generally requires a specific charging force which may further vary in function of time and temperature. With the type of wood that is used as an input, the electronic load cell 188 is therefore able to automatically calibrate itself and provide the required charging force. When a drive unit is used, the drive unit can be provided with this type of information instead.

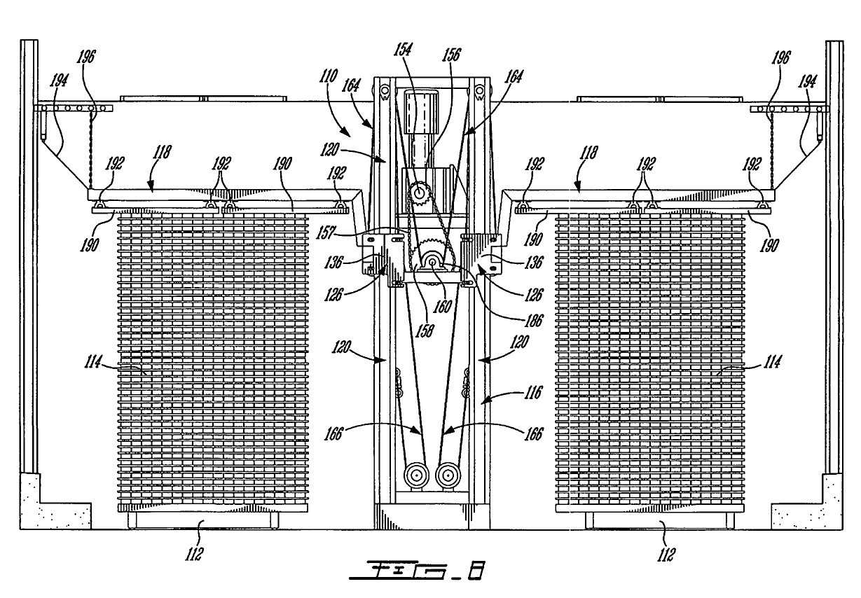

In this example, and as may be seen in more detail in FIG. 8, the pressing members 118 include stabilizers 190. The stabilizers 190 are provided below a frame of the pressing member 118. In this example, each pressing member 118 includes two independent stabilizers 190, each stabilizer spanning one transversal half of the pressing member 118. The stabilizers 190 include transversally and longitudinally extending beams to spread the force applied by the pressing member 118 onto a stack of lumber. The stabilizers 190 are resiliently mounted to the pressing member 118. In this example, the stabilizers 190 are connected to the frame of the pressing member 118 by a plurality of identical resilient connectors 192. These connectors 192 can be coil springs or rubber spacers, for example. The stabilizers 190 compensate for unevenness in the height of the stacks of lumber in each opposed loading areas 112. When used in an embodiment having a single or independent pressing members 18, the stabilizers can be used to compensate for unevenness in the longitudinal height of the stacks of lumber. In an alternate embodiment, the stabilizers can be positioned on the stacked lumber instead of underneath the pressing member. The stabilizers may alternately be made, for example, in a semi rigid material, such as rubber, for providing damping means when the pressing member 118 is in the pressing position.

In an alternate embodiment, the pressing device 110 can include a security stopper system which is complementary to the brake of the electric motor (not shown). The security system includes a male member in the form of a security pin and a female member in the form of a recess. The male portion is rigidly mounted to the frame and is oriented toward the recess. The recess is rigidly mounted or welded to the pressing member 118, such that the recess is oriented toward the security pin. The security stopper system can be electrically or manually operated such that the male portion is extended into the female receiver to lock the pressing member 118 into position. Hence, the pressing member 118 can be locked into the loading position by the braking system when the pressing device 110 is not in operation.

Referring to FIG. 8, in this example, two air deflectors 194 are provided with the pressing device 110, each air deflector 194 being associated with a respective pressing member 118. The two air deflectors 194 are identical; therefore, only one will be described in further detail. One side of the air deflector 194 is pivotally mounted to the ceiling of the dryer, and the free side of the air deflector 194 rests atop the pressing member 118. The length of the air deflector 194 is sufficient for the free end to be horizontally displaced along the pressing member 118 as the pressing member 118 is moved up and down. The free end of the pressing member 118 can be connected to the ceiling of the dryer by a chain 196, for example, to keep the free end from falling off the pressing member 118 if the pressing member 118 is lowered more than a predetermined elevation, to allow the free side to reengage the upper face of the pressing member 118 when the pressing member 118 is lifted above that predetermined elevation.

Many alternative designs can be made to the examples of improved pressing devices described above and illustrated, as will be appreciated by those skilled in the art. Some additional examples will be given to illustrate this.

Although the pressing members described above were described as being purely horizontal, in an alternate embodiment, they can be provided with a slight incline as they extend away from the guiding members. In fact, depending on the type of material used for the pressing member, which can be various, the downward compressive force can noticeably flex the pressing member. Here, a slight inclination of, for example, less than 5° can act to compensate for this flexion and contribute to a better transversal dispersion of the downward compressive force. This is less of an issue when stabilizers are used.

Although the pressing members described had a cross-hatched configuration, many suitable alternate configurations will be readily appreciated by those skilled in the art. For example, the pressing member can have a flat plate mounted below it to distribute the downward compressive force even more evenly. In an alternate embodiment, the pressing member can consist of a single transversally extending beam, for example.

Similarly, although in the examples given above two guiding members were used to slidably connect each pressing member, in an alternate embodiment, there can be provided only a single guiding member, for example. Further, instead of being cantilevered respective to the guiding members, the pressing member can be slidably connected to guiding members at both sides thereof, on either side of the stack loading area. Alternate configurations of guiding members are possible. The guiding member and sliding support can be a tube and post arrangement or any other suitable sliding assembly. In other alternate embodiments, it can be a rack and pinion assembly or a cushion assembly, for example.

In the example illustrated in FIG. 1, the pressing device in fact included two independent pressing devices with a single frame, and the frame was provided centrally relative to the dryer. In an alternate embodiment, a pressing device having a single pressing member can be mounted on the side of a dryer, for example, and the guiding member can be mounted directly to a side wall of the dryer. In another embodiment, the pressing member can be the ceiling of the dryer which slides along each sidewall of the dryer, where the sidewalls would act as guiding members. The pressing members can be sustained by both sides, instead of being cantilevered. Similarly, when a motor is used, the motor can be provided either in the dryer or outside the dryer.

Further, other means for moving the pressing member can be provided. In a simple embodiment, a manual crank linked to the pressing member by a pulley system can be used. In such an embodiment, a spring can be used, linked with the cable, to adjust the pressure exerted by the pressing member by extending the spring with each notch of the crank. In another such alternate embodiment, the weight of the pressing member can be used to generate the downward compressive force to the stacked lumber, and crank means can be provided for the sole purpose of lifting the pressing member, or letting go of the pressing member for it to apply its weight. In an alternate embodiment, the means for moving the pressing member while holding it from one side can be pneumatic, hydraulic, or mechanical and use pneumatic or hydraulic cylinders or a gearbox.

The number of pulleys used to multiply the motor torque was intended to maximize the multiplication of the motor torque. In other embodiments, more, less, or no multiplication can alternately be used by using more or less than the number of pulleys cited as examples. Further, it will be understood by those skilled in the art that chains and gears or the like can replace pulleys and cables.

In still another alternate embodiment, the pressing members could be lockingly pivotally mounted to the sliding support so as to be pivotable into a resting position alongside the guiding members when the pressing device is inoperative. The pressing members would then be pivoted back into a substantially horizontal position and locked into such position to bring the pressing device back into use.

Although in the example, stopper plates were used to limit the vertical displacement of the pressing members, other means can be used. For example, the vertical position of the fixed pulleys of the lifting assembly can be used to limit the vertical displacement of the pressing member in the upward direction, and the vertical position of the fixed pulleys of the lowering assembly can be used to limit the vertical displacement of the pressing member in the downward direction.

It is to be noted that various materials can be used in the different components described. In some embodiments, the structure is entirely painted with a heat-resistant, anti-corrosive coating to resist to the drying process.

As can be seen therefore, the examples described above and illustrated are intended to be exemplary only. Hence, the scope of the improvements is intended to be limited solely by the scope of the appended claims.

What is clammed is:

1. A pressing device for use in a lumber dryer having a stack loading area, the pressing device comprising:
at least one guiding member extending substantially vertically; and
a pressing member slidably connected to the guiding member, the pressing member extending substantially horizontally above the lumber stack loading area and being slidable between a loading position and a pressing position, a downward compressive force being applied by the pressing member to a lumber stack loaded in the stack loading area of the dryer when the pressing member is in the pressing position.

2. The pressing device of claim 1 wherein the pressing member is cantilevered relative to the guiding member.

3. The pressing device of claim 1 wherein the pressing member is moved by an actuator assembly, the actuator assembly being driven by an electric motor.

4. The pressing device of claim 3 wherein the actuator assembly has a pulley system connecting the electric motor to the pressing device, the pulley system including a lifting pulley assembly for moving the pressing member in an upward direction, and a lowering pulley assembly for moving the pressing member in a downward direction.

5. The pressing device of claim 1 wherein the pressing member includes a stabilizer resiliently mounted below it.

6. The pressing device of claim 1 wherein the guiding member is located on the side of the lumber stack loading area.

7. The pressing device of claim 1 wherein the guiding member comprises a rail to which is engaged a sliding assembly that is affixed to the pressing member.

8. The pressing device of claim 7 wherein the sliding assembly extends along a substantial portion of the rail for offering leverage against force applied to the pressing member.

9. The pressing device of claim 1 wherein there are at least two guiding members, the guiding members being spaced apart and disposed on the side of the lumber stack loading area.

10. The pressing device of claim 1 wherein the pressing member includes a plurality of interconnected longitudinally-disposed and transversally-disposed beams extending in a common plane.

11. The pressing device of claim 1 further comprising an air deflector adjacent to a gap between an edge of the pressing member and the ceiling of the lumber dryer.

12. The pressing device of claim 11 wherein the air deflector is pivotally mounted to the ceiling and is pivotable by the sliding movement of the pressing member to maintain said gap closed independently of the vertical position of the pressing member.

13. A pressing device for use in a lumber dryer having a lumber loading area, the pressing device comprising:
a pressing member extending substantially horizontally above the lumber loading area;
means for vertically moving the pressing member while holding it from a side thereof so as to apply a downward compressive force to a lumber stack in the lumber loading area.

14. The pressing device of claim 13 wherein the means for vertically moving include at least one guiding member extending substantially vertically, and an actuator assembly for sliding the pressing member along the guiding member.

15. The pressing device of claim 14 wherein the pressing member is cantilevered relative to the guiding member.

16. The pressing device of claim 13 wherein the actuator assembly is driven by an electric motor.

17. The pressing device of claim 16 wherein the actuator assembly has a pulley system connecting the electric motor to the pressing device, the pulley system including a lifting pulley assembly for moving the pressing member in an upward direction, and a lowering pulley assembly for moving the pressing member in a downward direction.

18. The pressing device of claim 13 wherein the pressing member includes a stabilizer resiliently mounted below it.

19. The pressing device of claim 14 wherein the guiding member is located on the side of the lumber stack loading area.

20. The pressing device of claim 14 wherein the guiding member comprises a rail to which is engaged a sliding assembly that is affixed to the pressing member.

21. The pressing device of claim 20 wherein the sliding assembly extends along a substantial portion of the rail for offering leverage against force applied to the pressing member.

22. The pressing device of claim 14 wherein there are at least two guiding members, the guiding members being spaced apart and disposed on the side of the lumber stack loading area

23. The pressing device of claim 13 wherein the pressing member includes a plurality of interconnected longitudinally-disposed and transversally-disposed beams extending in a common plane.

24. The pressing device of claim 13 further comprising an air deflector adjacent to a gap between an edge of the pressing member and the ceiling of the lumber dryer.

25. The pressing device of claim 24 wherein the air deflector is pivotally mounted to the ceiling and is pivotable by the sliding movement of the pressing member to maintain said gap closed independently of the vertical position of the pressing member.

26. A method of maintaining a stack of lumber during drying, the method comprising:
supporting a substantially horizontal pressing member from one side thereof;
positioning a stack of lumber beneath the pressing member;
moving the pressing member downwardly while keeping it in a substantially horizontal position until it makes contact with an upper portion of the stack of lumber; and
continuing to move the pressing member so as to apply a downward compressive force to the stack of lumber.

27. The method of claim 26 further comprising:
venting hot air onto the compressed stack of lumber; and then
raising the pressing member out of engagement with the stack of lumber.
